(19) United States
(12) Patent Application Publication
(10) Pub. No.: US 2026/0112306 A1
(43) Pub. Date: Apr. 23, 2026

(54) DISPLAY DEVICE AND ELECTRONIC DEVICE INCLUDING THE DISPLAY DEVICE

(71) Applicant: Samsung Display Co., LTD., Yongin-si (KR)

(72) Inventors: Kyeongmin Park, Yongin-si (KR); KYUNG-BAE KIM, Yongin-si (KR); SANGHYUN HEO, Yongin-si (KR)

(21) Appl. No.: 19/252,540

(22) Filed: Jun. 27, 2025

(30) Foreign Application Priority Data
Oct. 21, 2024 (KR) 10-2024-0144241

(51) Int. Cl. G09G 3/32

(52) U.S. Cl. CPC G09G 3/32; G09G 2300/0819; G09G 2300/0842; G09G 2300/0861; G09G 2310/0297; G09G 2320/02

(57) ABSTRACT

A display device includes a display panel including a first data line, a second data line, a first gate line, a second gate line, a first pixel connected to the first data line and the first gate line, and a second pixel connected to the second data line and the second gate line. The display device includes a data driver including an output channel which provides a first data voltage and a second data voltage to each of the first data line and the second data line, a gate driver which respectively provides a first gate signal and a second gate signal to the first gate line and the second gate line, and a demultiplexer which selectively connects the first data line to the output channel in response to a first switching signal and selectively connects the second data line to the output channel in response to a second switching signal.

This application claims priority to Korean Patent Application No. 10-2024-0144241, filed on Oct. 21, 2024, and all the benefits accruing therefrom under 35 U.S.C. § 119, the content of which in its entirety is herein incorporated by reference.

### BACKGROUND

### 1. Field

Embodiments supported by the present disclosure relate to a display device and an electronic device including the display device. More particularly, embodiments of the present disclosure relate to a display device and an electronic device including the display device, in which the electronic device includes a demultiplexer.

### 2. Description of the Related Art

Recently, a display device for providing a virtual reality (VR) or augmented reality (AR) has been highlighted. For this purpose, display devices having a small area and a high PPI (Pixels Per Inch) are desired, and a reduced pitch of an output channel of a data driver may be desired.

In order to reduce the pitch of the output channel of the data driver, the display device may further include a demultiplexer. The demultiplexer may selectively apply data voltages to data lines, and the data voltages may be selectively applied to pixels.

However, when the data voltages are selectively applied to the pixels, noise voltages may be applied to the pixels, and a display quality of the display device may be reduced.

### SUMMARY

Embodiments supported by the present disclosure provide a display device for providing an improved display quality even when using a demultiplexer.

Embodiments supported by the present disclosure provide an electronic device including the display device.

In an embodiment of a display device according to the present inventive concept, the display device includes a display panel including a first data line, a second data line, a first gate line, a second gate line, a first pixel connected to the first data line and the first gate line, and a second pixel connected to the second data line and the second gate line, a data driver including an output channel which provides a first data voltage and a second data voltage to each of the first data line and the second data line, a gate driver which respectively provides a first gate signal and a second gate signal to the first gate line and the second gate line, and a demultiplexer which selectively connects the first data line to the output channel in response to a first switching signal and selectively connects the second data line to the output channel in response to a second switching signal.

In an embodiment, the demultiplexer may include a first switching element which selectively connects the first data line to the output channel in response to the first switching signal, and a second switching element which selectively connects the second data line to the output channel in response to the second switching signal.

In an embodiment, each of the first gate signal and the first switching signal may have an on-level in a first duration and an off-level in a second duration.

In an embodiment, each of the second gate signal and the second switching signal may have the on-level in the first duration and the off-level in the second duration.

In an embodiment, the first duration and the second duration may be different with respect to time.

In an embodiment, the first duration and the second duration may each have a time length shorter than one frame.

In an embodiment, a first switching element included in the demultiplexer may turn on in response to the first switching signal having the on-level in the first duration, and may turn off in response to the first switching signal having the off-level in the second duration.

In an embodiment, a second switching element included in the demultiplexer may turn off in response to the second switching signal having the off-level in the first duration, and may turn on in response to the second switching signal having the on-level in the second duration.

In an embodiment, the output channel may output the first data voltage in the first duration and output the second data voltage in the second duration.

In an embodiment, each of the first pixel and the second pixel may include a driving transistor which generates a driving current, and a data write transistor. The data write transistor included in the first pixel may transmit each of the first data voltage and the second data voltage to the driving transistor included in the first pixel, based on the first gate signal. The data write transistor included in the second pixel may transmit each of the first data voltage and the second data voltage to the driving transistor included in the second pixel based, on the second gate signal.

In an embodiment, the data write transistor of the first pixel may turn on in response to the first gate signal having the on-level in the first duration, and may turn off in response to the first gate signal having the off-level in the second duration.

In an embodiment, the data write transistor of the second pixel may turn off in response to the second gate signal having the off-level in the first duration, and may turn on in response to the second gate signal having the on-level in the second duration.

In an embodiment, the first pixel and the second pixel may be included in a same pixel row.

In an embodiment, the first pixel and the second pixel may be arranged adjacent to each other.

In an embodiment, each of the first pixel and the second pixel may include a driving transistor including a gate electrode connected to a first node, a first electrode connected to a first power supply voltage line which supplies a first power supply voltage, and a second electrode, a data write transistor including a gate electrode which receives a data write gate signal, a first electrode connected to a data line which transmits a data voltage, and a second electrode connected to the first node, a storage capacitor including a first electrode connected to the first power supply voltage line and a second electrode connected to the first node, and a light emitting element including an anode connected to the second electrode of the driving transistor and a cathode connected to a second power supply voltage line which supplies a second power supply voltage.

In an embodiment, each of the first pixel and the second pixel may include a driving transistor including a gate electrode connected to a first node, a first electrode connected to a first power supply voltage line which supplies a first power supply voltage, and a second electrode connected to a second node, a data write transistor including a gate electrode which receives a data write gate signal, a first electrode connected to a data line which transmits a data voltage, and a second electrode connected to a third node, a compensation transistor including a gate electrode which receives a compensation gate signal, a first electrode connected to the second node, and a second electrode connected to the first node, a light emitting control transistor including a gate electrode which receives an emission signal, a first electrode connected to the second node, and a second electrode connected to a fourth node, a storage capacitor including a first electrode connected to the third node and a second electrode connected to the first node, and a light emitting element including an anode connected to the fourth node and a cathode connected to a second power supply voltage line which supplies a second power supply voltage.

In an embodiment, each of the first pixel and the second pixel may further include an anode initialization transistor including a gate electrode which receives an anode initialization gate signal, a first electrode connected to an initialization voltage line which supplies an initialization voltage, and a second electrode connected to the fourth node.

In an embodiment, each of the first pixel and the second pixel may further include a third node initialization transistor including a gate electrode which receives a third node initialization gate signal, a first electrode connected to a reference voltage line which supplies a reference voltage, and a second electrode connected to the third node, and a first node initialization transistor including a gate electrode which receives a first node initialization gate signal, a first electrode connected to the reference voltage line, and a second electrode connected to the first node.

In an embodiment, each of the first pixel and the second pixel may include a driving transistor including a gate electrode connected to a first node, a first electrode connected to a second node, and a second electrode connected to a third node, a data write transistor including a gate electrode which receives a data write gate signal, a first electrode connected to a data line which transmits a data voltage, and a second electrode connected to the first node, a light emitting control transistor including a gate electrode which receives an emission signal, a first electrode connected to a first power supply voltage line which supplies a first power supply voltage, and a second electrode connected to the second node, a first capacitor including a first electrode connected to the second node and a second electrode connected to the first node, a third capacitor including a first electrode connected to the first node and a second electrode connected to the third node, and a light emitting element including an anode connected to the third node and a cathode connected to a second power supply voltage line which supplies a second power supply voltage.

In an embodiment of an electronic device according to the present inventive concept, the electronic device includes a display panel including a first data line, a second data line, a first gate line, a second gate line, a first pixel connected to the first data line and the first gate line, and a second pixel connected to the second data line and the second gate line, a data driver including an output channel which provides a first data voltage and a second data voltage to each of the first data line and the second data line, a gate driver which respectively provides a first gate signal and a second gate signal to the first gate line and the second gate line, a demultiplexer which selectively connects the first data line to the output channel in response to a first switching signal and selectively connects the second data line to the output channel in response to a second switching signal, a driving controller which controls the data driver and the gate driver, and a processor which controls the driving controller.

According to the display device and the electronic device, data write transistors included in pixels in a same pixel row may turn on according to different timings in response to a plurality of data write gate signals. In this case, the data write transistors of the pixels to which the data voltage is not applied are turned off, such that noise voltage is not be applied to the pixels.

### BRIEF DESCRIPTION OF THE DRAWINGS

The above and other features of embodiments of the present disclosure will become more apparent by describing in detailed embodiments thereof with reference to the accompanying drawings, in which:

FIG. 1 is a block diagram illustrating a display device according to embodiments of the present disclosure;

FIG. 2 is a circuit diagram illustrating an example of a pixel of FIG. 1;

FIG. 3 is a circuit diagram illustrating pixels included in a same pixel row of FIG. 1, a demultiplexer connected to the pixels, and an output channel;

FIG. 4 is a timing diagram illustrating gate signals, switching signals, and data voltages of FIG. 3;

FIG. 5 is a diagram illustrating an operation of pixels, a demultiplexer, and an output channel of FIG. 3 in a first duration of FIG. 4;

FIG. 6 is a diagram illustrating an operation of pixels, a demultiplexer, and an output channel of FIG. 3 in a second duration of FIG. 4;

FIG. 7 is a diagram illustrating an operation of pixels, a demultiplexer, and an output channel of FIG. 3 in a K-th duration of FIG. 4;

FIG. 8 is a circuit diagram illustrating an example of a pixel of FIG. 1;

FIG. 9 is a circuit diagram illustrating an example of a pixel of FIG. 1;

FIG. 10 is a circuit diagram illustrating an example of a pixel of FIG. 1;

FIG. 11 is a block diagram illustrating an electronic device; and

FIG. 12 is a diagram illustrating an embodiment in which an electronic device of FIG. 11 is implemented as a smartphone.

### DETAILED DESCRIPTION

Hereinafter, embodiments of the present disclosure will be described in more detail with reference to the accompanying drawings.

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of the invention to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as, for example, “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

The terms “high level” (or alternatively, “high voltage level” or “on-level”) and “low level” (or alternatively, “low voltage level” or “off-level”) are relative terms describing levels of voltages which, when applied to a transistor described herein, may activate a transistor (e.g., turn “ON” the transistor) or deactivate a transistor (e.g., turn “OFF”the transistor) based on transistor type (e.g., P-type, N-type, or the like).

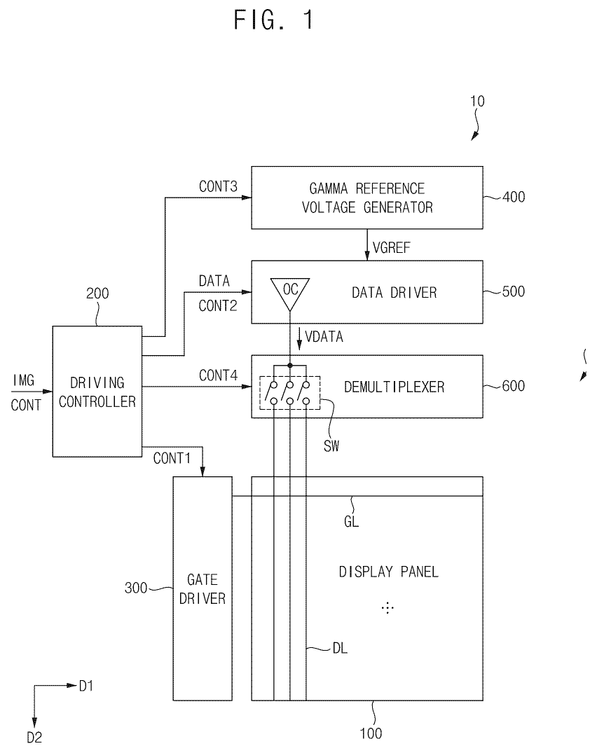

FIG. 1 is a block diagram illustrating a display device 10 according to embodiments of the present disclosure.

Referring to FIG. 1, a display device 10 may include a display panel 100 and a display panel driver. The display panel driver may include a driving controller 200, a gate driver 300, a gamma reference voltage generator 400, and a data driver 500. The display panel driver may further include a demultiplexer 600.

The display panel 100 may include a display area for displaying an image and a peripheral area arranged adjacent to the display area.

The display panel 100 may include gate lines GL, data lines DL, and pixels electrically connected to the gate lines GL and the data lines DL, respectively. The gate lines GL may extend in a first direction D1, and the data lines DL may extend in a second direction D2 crossing the first direction D1.

The driving controller 200 may receive input image data IMG and an input control signal CONT from an external device (not illustrated). For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the demultiplexer 600 based on the input control signal CONT, and output the fourth control signal CONT4 to the demultiplexer 600.

The gate driver 300 may generate gate signals for driving the gate lines GL in response to the first control signal CONT1 received from the driving controller 200. The gate driver 300 may output the gate signals to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be arranged in the driving controller 200 or may be arranged in the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage VDATA having an analog type using the gamma reference voltage VGREF. The data driver 500 may include a output channel OC which generate the data voltage VDATA and output the data voltage VDATA.

The demultiplexer 600 may include switching elements SW and may control the switching elements SW based on the fourth control signal CONT4 received from the driving controller 200. The demultiplexer 600 may control the switching elements SW to selectively connect the output channel OC to each of the data lines DL.

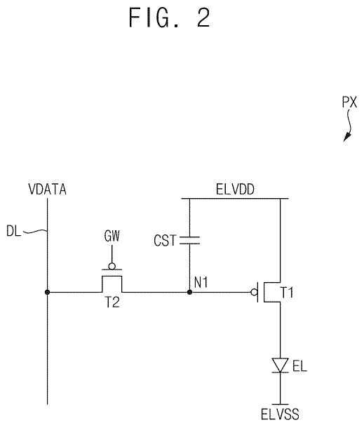

FIG. 2 is a circuit diagram illustrating an example of a pixel PX of FIG. 1.

Referring to FIG. 2, the pixel PX may include a first transistor T1, a second transistor T2, a storage capacitor CST, and a light emitting element EL.

The first transistor T1 may include a gate electrode connected to a first node N1, a first electrode connected to a first power supply voltage line which supplies a first power supply voltage ELVDD, and a second electrode. The first transistor T1 may generate a driving current based on a voltage of the first node N1. The first transistor T1 may be referred to as a driving transistor.

The second transistor T2 may include a gate electrode which receives a data write gate signal GW, a first electrode connected to a data line DL which transmits a data voltage VDATA, and a second electrode connected to the first node N1. The second transistor T2 may turn on in response to the data write gate signal GW and transmit the data voltage VDATA to the first node N1. The second transistor T2 may be referred to as a data write transistor.

The storage capacitor CST may include a first electrode connected to the first power supply voltage line and a second electrode connected to the first node N1. The storage capacitor CST may store a voltage corresponding to the data voltage VDATA.

The light emitting element EL may include an anode connected to the second electrode of the first transistor T1 and a cathode connected to a second power supply voltage line which supplies a second power supply voltage ELVSS. The light emitting element EL may emit a light based on the driving current.

In FIG. 2, the pixel PX is illustrated as including two transistors and one capacitor, but embodiments of the present disclosure are not limited thereto. The pixel PX of the embodiments of the present disclosure may include at least three or more transistors or at least two or more capacitors.

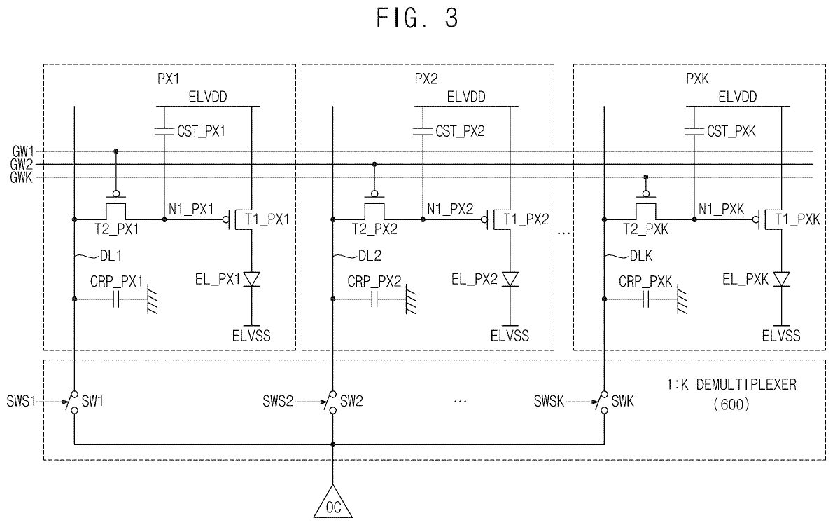

FIG. 3 is a circuit diagram illustrating pixels PX1, PX2, . . . , PXK included in a same pixel row of FIG. 1, a demultiplexer 600 connected to the pixels PX1, PX2, . . . , PXK, and an output channel OC.

Referring to FIG. 3, the same pixel row may include the plurality of pixels PX1, PX2, . . . , PXK. For example, the same pixel row may include first to K-th pixels PX1, PX2, . . . , PXK (where K is a positive integer greater than or equal to 2). The first to K-th pixels PX1, PX2, . . . , PXK may be arranged adjacent to each other. In FIG. 3, the same pixel row illustrates three pixels PX1, PX2, PXK, but embodiments of the present disclosure are not limited thereto.

The first pixel PX1 may include a first transistor T1_PX1, a second transistor T2_PX1, a storage capacitor CST_PX1, and a light emitting element EL_PX1. The first transistor T1_PX1 may include a gate electrode connected to a first node N1_PX1, a first electrode connected to a first power supply voltage line which supplies a first power supply voltage ELVDD, and a second electrode. The second transistor T2_PX1 may include a gate electrode which receives a first data write gate signal GW1, a first electrode connected to a first data line DL1, and a second electrode connected to the first node N1_PX1. The storage capacitor CST_PX1 may include a first electrode connected to the first power supply voltage line and a second electrode connected to the first node N1_PX1. The light emitting element EL_PX1 may include an anode connected to the second electrode of the first transistor T1_PX1 and a cathode connected to a second power supply voltage line which supplies a second power supply voltage ELVSS. The first pixel PX1 may further include a parasitic capacitor CPR_PX1. In some cases, (not illustrated), the parasitic capacitor CPR_PX1 may be connected to the first data line DL1.

The second pixel PX2 may include a first transistor T1_PX2, a second transistor T2_PX2, a storage capacitor CST_PX2, and a light emitting element EL_PX2. The first transistor T1_PX2 may include a gate electrode connected to a first node N1_PX2, a first electrode connected to the first power supply voltage line, and a second electrode. The second transistor T2_PX2 may include a gate electrode which receives a second data write gate signal GW2, a first electrode connected to a second data line DL2, and a second electrode connected to the first node N1_PX2. The storage capacitor CST_PX2 may include a first electrode connected to the first power supply voltage line and a second electrode connected to the first node N1_PX2. The light emitting element EL_PX2 may include an anode connected to the second electrode of the first transistor T1_PX2 and a cathode connected to the second power supply voltage line. The second pixel PX2 may further include a parasitic capacitor CPR_PX2. In some cases, (not illustrated), the parasitic capacitor CPR_PX2 may be connected to the second data line DL2.

The K-th pixel PXK may include a first transistor T1_PXK, a second transistor T2_PXK, a storage capacitor CST_PXK, and a light emitting element EL_PXK. The first transistor T1_PXK may include a gate electrode connected to a first node N1_PXK, a first electrode connected to the first power supply voltage line, and a second electrode. The second transistor T2_PXK may include a gate electrode which receives a K-th data write gate signal GWK, a first electrode connected to the K-th data line DLK, and a second electrode connected to the first node N1_PXK. The storage capacitor CST_PXK may include a first electrode connected to the first power supply voltage line and a second electrode connected to the first node N1_PXK. The light emitting element EL_PXK may include an anode connected to the second electrode of the first transistor T1_PXK and a cathode connected to the second power supply voltage line transmitting the second power supply voltage ELVSS. The K-th pixel PXK may further include a parasitic capacitor CPR_PXK. In some cases, (not illustrated), the parasitic capacitor CPR_PXK may be connected to the K-th data line DLK.

The demultiplexer 600 may selectively connect an output channel OC to each of the data lines DL1, DL2, . . . , DLK. For example, the demultiplexer 600 may be a 1:K demultiplexer and may include first to K-th switching elements SW1, SW2, . . . , SWK.

The first switching element SW1 may turn on in response to a first switching signal SWS1 and connect the output channel OC and the first data line DL1. The second switching element SW2 may turn on in response to a second switching signal SWS2 and connect the output channel OC and the second data line DL2. The K-th switching element SWK may turn on in response to a K-th switching signal SWSK and connect the output channel OC and the K-th data line DLK.

The output channel OC may be connected to the first to K-th switching elements SW1, SW2, . . . , SWK. The output channel OC may generate and output a data voltage VDATA.

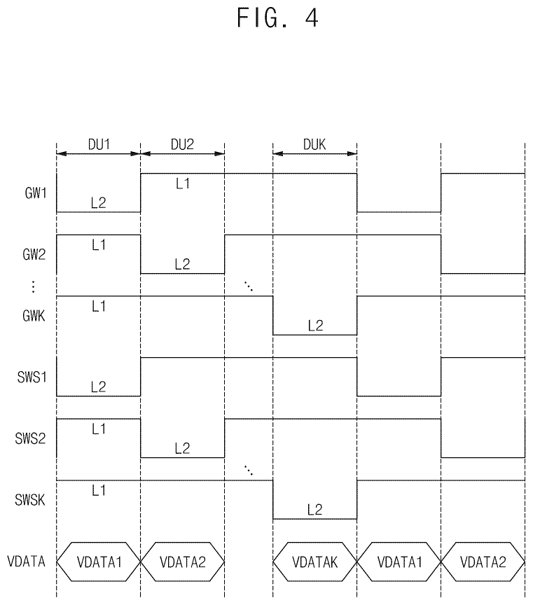

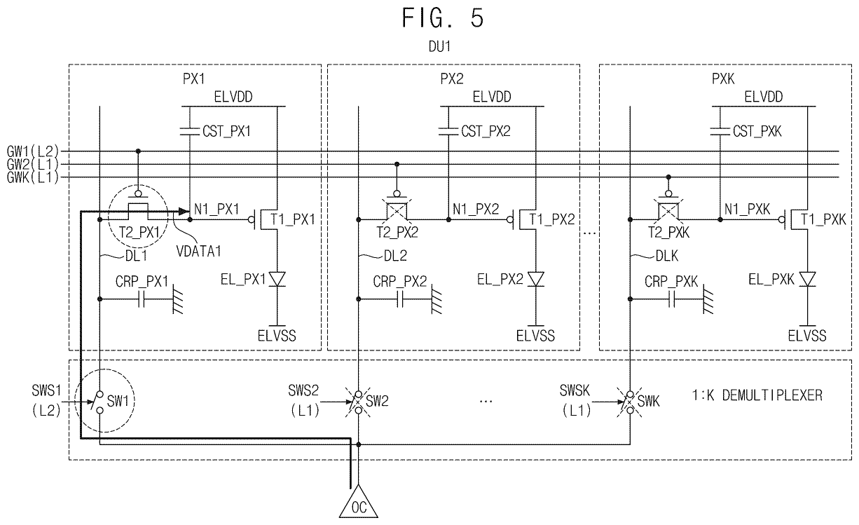

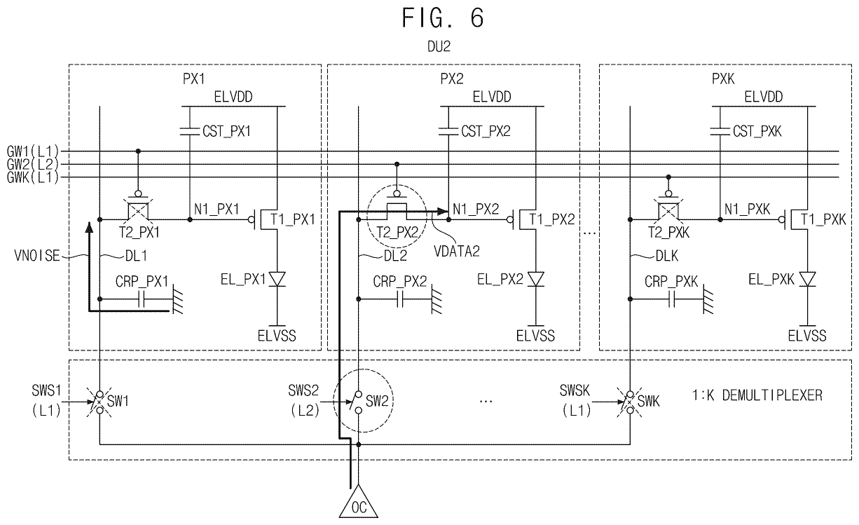

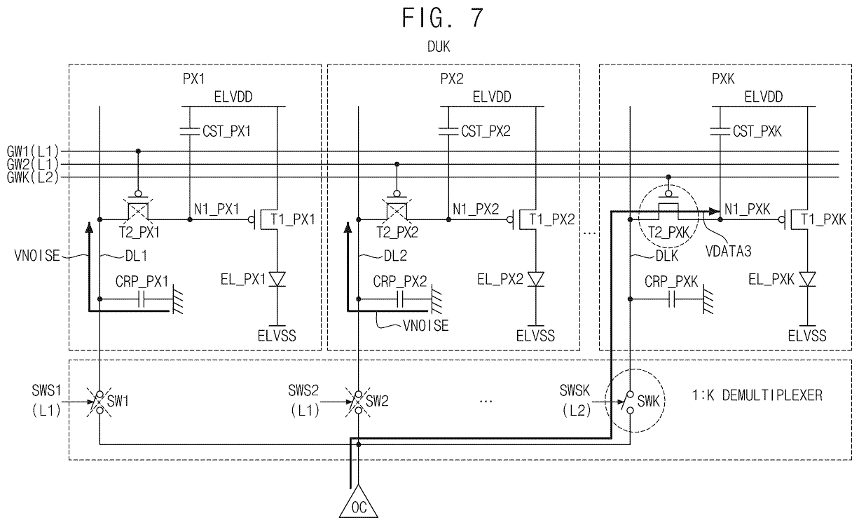

FIG. 4 is a timing diagram illustrating gate signals GW1, GW2, . . . , GWK, switching signals SWS1, SWS2, . . . ,SWSK, and data voltages VDATA1, VDATA2,. VDATAK of FIG. 3. FIG. 5 is a diagram illustrating an operation of pixels PX1, PX2, . . . , PXK, a demultiplexer 600, and an output channel OC of FIG. 3 in a first duration DU1 of FIG. 4. FIG. 6 is a diagram illustrating an operation of pixels PX1, PX2, . . . , PXK, a demultiplexer 600, and an output channel OC of FIG. 3 in a second duration DU2 of FIG. 4. FIG. 7 is a diagram illustrating an operation of pixels PX1, PX2, . . . , PXK, a demultiplexer 600, and an output channel OC of FIG. 3 in a K-th duration DUK of FIG.

Referring to FIG. 4, pixels PX1, PX2, . . . , PXK included in a same pixel row, switching elements SW1, SW2, . . . , SWK included in the demultiplexer 600, and an output channel OC may operate in first to K-th durations DU1 to DUK. The first to K-th durations DU1 to DUK may be durations in which a data voltage VDATA is applied to the pixels PX1, PX2, . . . , PXK included in the same pixel row. Therefore, the first to K-th durations DU1 to DU3 may each have a time length less than one frame.

In the first duration DU1, the first data write gate signal GW1 may have an on-level L2, the second data write gate signal GW2 may have an off-level L1, the K-th data write gate signal GWK may have the off-level L1, a first switching signal SWS1 may have the on-level L2, a second switching signal SWS2 may have the off-level L1, the K-th switching signal SWSK may have the off-level L1, and the data voltage VDATA may have a first data voltage VDATA1.

In the second duration DU2, the first data write gate signal GW1 may have the off-level L1, the second data write gate signal GW2 may have the on-level L2, the K-th data write gate signal GWK may have the off-level L1, the first switching signal SWS1 may have the off-level L1, the second switching signal SWS2 may have the on-level L2, the K-th switching signal SWSK may have the off-level L1, and the data voltage VDATA may have a second data voltage VDATA2.

In the K-th duration DUK, the first data write gate signal GW1 may have the off-level L1, the second data write gate signal GW2 may have the off-level L1, the K-th data write gate signal GWK may have the on-level L2, the first switching signal SWS1 may have the off-level L1, the second switching signal SWS2 may have the off-level L1, the K-th switching signal SWSK may have the on-level L2, and the data voltage VDATA may have a K-th data voltage VDATAK.

Referring to FIG. 5, in the first duration DU1, the output channel OC may generate and output the first data voltage VDATA1.

The first switching element SW1 may turn on in response to the first switching signal SWS1 having the on-level L2 and connect the output channel OC and the first data line DL1. Therefore, the first data voltage VDATA1 may be transmitted to the first data line DL1. In this case, the noise voltage VNOISE may be transmitted to the first data line DL1 through the parasitic capacitor CPR_PX1 of the first pixel PX1, but since the voltage of the first data line DL1 is forcibly fixed by the first data voltage VDATA1 transmitted from the output channel OC, the voltage of the first data line DL1 may not be affected by the noise voltage VNOISE.

The second transistor T2_PX1 of the first pixel PX1 may turn on in response to the first data write gate signal GW1 having the on-level L2 and transmit the first data voltage VDATA1 to the first node N1_PX1 of the first pixel PX1. Therefore, the voltage of the first node N1_PX1 of the first pixel PX1 may be the first data voltage VDATA1.

The second switching element SW2 may turn off in response to the second switching signal SWS2 having the off-level L1. The second transistor T2_PX2 of the second pixel PX2 may turn off in response to the second data write gate signal GW2 having the off-level L1. Therefore, the first data voltage VDATA1 may not be delivered to the first node N1_PX2 of the second pixel PX2.

The K-th switching element SWK may turn off in response to the K-th switching signal SWSK having the off-level L1. The second transistor T2_PXK of the K-th pixel PXK may turn off in response to the K-th data write gate signal GWK having the off-level L1. Therefore, the first data voltage VDATA1 may not be delivered to the first node N1_PX2 of the second pixel PX2.

Referring to FIG. 6, in the second duration DU2, the output channel OC may generate and output the second data voltage VDATA2.

The second switching element SW2 may turn on in response to the second switching signal SWS2 having the on-level L2 and connect the output channel OC and the second data line DL2. Therefore, the second data voltage VDATA2 may be transmitted to the second data line DL2. In this case, the noise voltage VNOISE may be transmitted to the second data line DL2 through the parasitic capacitor CPR_PX2 of the second pixel PX2, but since the voltage of the second data line DL2 is forcibly fixed by the second data voltage VDATA2 transmitted from the output channel OC, the voltage of the second data line DL2 may not be affected by the noise voltage VNOISE.

The second transistor T2_PX2 of the second pixel PX2 may turn on in response to the second data write gate signal GW2 having the on-level L2 and transmit the second data voltage VDATA2 to the first node N1_PX2 of the second pixel PX2. Therefore, the voltage of the first node N1_PX2 of the second pixel PX2 may be the second data voltage VDATA2.

The first switching element SW1 may turn off in response to the first switching signal SWS1 having the off-level L1. In this case, since the noise voltage VNOISE is transmitted to the first data line DL1 through the parasitic capacitor CPR_PX1 of the first pixel PX1, the voltage of the first data line DL1 may be affected by the noise voltage VNOISE. However, the second transistor T2_PX1 of the first pixel PX1 may turn off in response to the first data write gate signal GW1 having the off-level L1. Therefore, the noise voltage VNOISE may not be transmitted to the first node N1_PX1 of the first pixel PX1, and the voltage of the first node N1_PX1 of the first pixel PX1 may be maintained as the first data voltage VDATA1.

The K-th switching element SWK may turn off in response to the K-th switching signal SWSK having the off-level L1. The second transistor T2_PXK of the K-th pixel PXK may turn off in response to the K-th data write gate signal GWK having the off-level L1. Therefore, the second data voltage VDATA2 may not be transmitted to the first node N1_PXK of the K-th pixel PXK.

Referring to FIG. 7, in the K-th duration DUK, the output channel OC may generate and output the K-th data voltage VDATAK.

The K-th switching element SWK may turn on in response to the K-th switching signal SWSK having the on-level L2 and connect the output channel OC and the K-th data line DLK. Therefore, the K-th data voltage VDATAK may be transmitted to the K-th data line DLK. In this case, the noise voltage VNOISE may be transmitted to the K-th data line DLK through the parasitic capacitor CPR_PXK of the K-th pixel PXK, but since the voltage of the K-th data line DLK is forcibly fixed by the K-th data voltage VDATAK transmitted from the output channel OC, the voltage of the K-th data line DLK may not be affected by the noise voltage VNOISE.

The third transistor T3_PXK of the K-th pixel PXK may turn on in response to the K-th data write gate signal GWK having the on-level L2 and transmit the K-th data voltage VDATAK to the first node N1_PXK of the K-th pixel PXK. Therefore, the voltage of the first node N1_PXK of the K-th pixel PXK may be the K-th data voltage VDATAK.

The first switching element SW1 may turn off in response to the first switching signal SWS1 having the off-level L1. In this case, since the noise voltage VNOISE is transmitted to the first data line DL1 through the parasitic capacitor CPR_PX1 of the first pixel PX1, the voltage of the first data line DL1 may be affected by the noise voltage VNOISE. However, the second transistor T2_PX1 of the first pixel PX1 may turn off in response to the first data write gate signal GW1 having the off-level L1. Therefore, the noise voltage VNOISE may not be transmitted to the first node N1_PX1 of the first pixel PX1, and the voltage of the first node N1_PX1 of the first pixel PX1 may be maintained as the first data voltage VDATA1.

The second switching element SW2 may turn off in response to the second switching signal SWS2 having the off-level L1. In this case, since the noise voltage VNOISE is transmitted to the second data line DL2 through the parasitic capacitor CPR_PX2 of the second pixel PX2, the voltage of the second data line DL2 may be affected by the noise voltage VNOISE. However, the second transistor T2_PX2 of the second pixel PX2 may turn off in response to the second data write gate signal GW2 having the off-level L1. Therefore, the noise voltage VNOISE may not be transmitted to the first node N1_PX2 of the second pixel PX2, and the voltage of the first node N1_PX2 of the second pixel PX2 may be maintained as the second data voltage VDATA2.

When a display device 10 uses a demultiplexer 600, a data voltage VDATA may be selectively applied to each of data lines DL connected to each of the pixels PX included in a same pixel row. Each of the pixels PX may include a data write transistor T2, and the data write transistor T2 may receive the data voltage VDATA in response to the data write gate signal GW.

In a conventional display device, the data write transistors included in the pixels of the same pixel row may turn on together in response to the same data write gate signal. In this case, since the data write transistors of the pixels to which the data voltage is not applied are also turned on, the noise voltage may be applied to the pixels.

In the display device 10 according to embodiments of the present disclosure, the data write transistors T2_PX1, T2_PX2, . . . , T2_PXK included in the pixels PX1, PX2, . . . , PXK of the same pixel row may respectively turn on according to different timings in response to a plurality of data write gate signals GW1, GW2, . . . , GWK. In this case, since data write transistors of pixels to which the data voltage VDATA is not applied are turned off, noise voltage VNOISE may be prevented from being applied to the pixels.

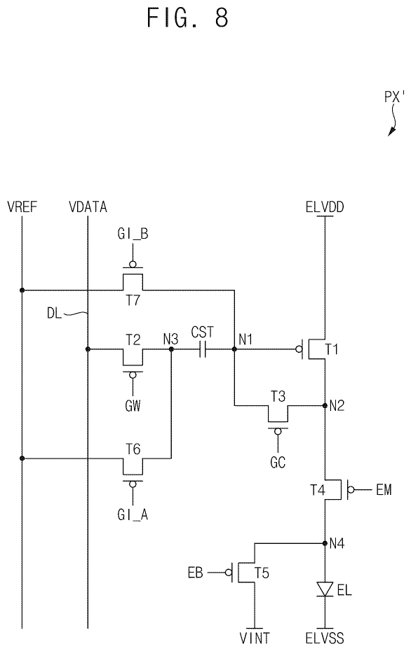

A person skilled in the art will appreciate that the pixel PX of the embodiments of the present disclosure may have any configuration. Examples of the pixel PX are described in FIGS. 8 to 10.

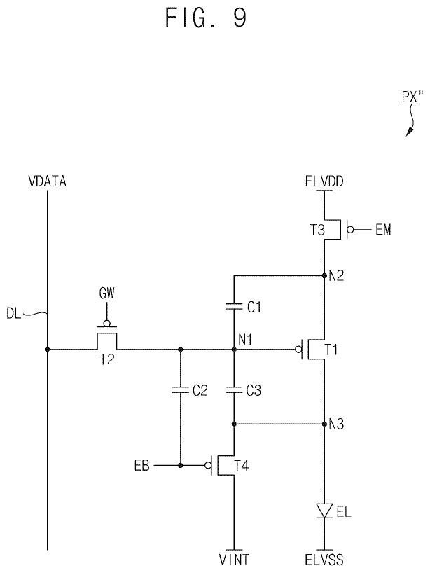

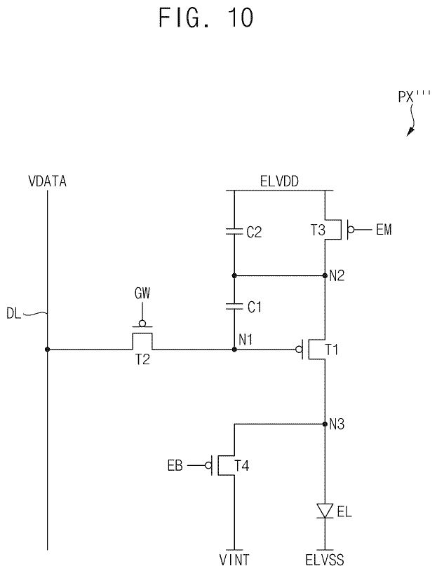

FIG. 8 is a circuit diagram illustrating an example PX′ of a pixel PX of FIG. 1. FIG. 9 is a circuit diagram illustrating an example PX″ of a pixel PX of FIG. 1. FIG. 10 is a circuit diagram illustrating an example PX″′ of a pixel PX of FIG. 1.

Referring to FIG. 8, the pixel PX′ may include a first transistor T1, a second transistor T2, a third transistor T3, a fourth transistor T4, a fifth transistor T5, a sixth transistor T6, a seventh transistor T7, a storage capacitor CST, and a light emitting element EL.

The first transistor T1 may include a gate electrode connected to a first node N1, a first electrode connected to a first power supply voltage line which supplies a first power supply voltage ELVDD, and a second electrode connected to a second node N2. The first transistor T1 may be referred to as a driving transistor.

The second transistor T2 may include a gate electrode which receives a data write gate signal GW, a first electrode connected to a data line DL which transmits a data voltage VDATA, and a second electrode connected to a third node N3. The second transistor T2 may be referred to as a data write transistor.

The third transistor T3 may include a gate electrode which receives a compensation gate signal GC, a first electrode connected to the second node N2, and a second electrode connected to the first node N1. The third transistor T3 may be referred to as a compensation transistor.

The fourth transistor T4 may include a gate electrode which receives an emission signal EM, a first electrode connected to the second node N2, and a second electrode connected to the fourth node N4. The fourth transistor T4 may be referred to as a light emitting control transistor.

The fifth transistor T5 may include a gate electrode which receives an anode initialization gate signal EB, a first electrode connected to an initialization voltage line which supplies an initialization voltage VINT, and a second electrode connected to the fourth node N4. The fifth transistor T5 may be referred to as an anode initialization transistor.

The sixth transistor T6 may include a gate electrode which receives a third node initialization gate signal GI_A, a first electrode connected to a reference voltage line which supplies a reference voltage VREF, and a second electrode connected to the third node N3. The sixth transistor T6 may be referred to as a third node initialization transistor.

The seventh transistor T7 may include a gate electrode which receives a first node initialization gate signal GI_B, a first electrode connected to the reference voltage line, and a second electrode connected to the first node N1. The seventh transistor T7 may be referred to as a first node initialization transistor.

The storage capacitor CST may include a first electrode connected to the third node N3 and a second electrode connected to the first node N1.

The light emitting element EL may include an anode connected to the fourth node N4 and a cathode connected to a second power supply voltage line which supplies a second power supply voltage ELVSS.

Referring to FIG. 9, the pixel PX″ may include a first transistor T1, a second transistor T2, a third transistor T3, a fourth transistor T4, a first capacitor C1, a second capacitor C2, a third capacitor C3, and a light emitting element EL.

The first transistor T1 may include a gate electrode connected to a first node N1, a first electrode connected to a second node N2, and a second electrode connected to a third node N3. The first transistor T1 may be referred to as a driving transistor.

The second transistor T2 may include a gate electrode which receives a data write gate signal GW, a first electrode connected to a data line DL which supplies a data voltage VDATA, and a second electrode connected to the first node N1. The second transistor T2 may be referred to as a data write transistor.

The third transistor T3 may include a gate electrode which receives an emission signal EM, a first electrode connected to a first power supply voltage line which supplies a first power supply voltage ELVDD, and a second electrode connected to the second node N2. The third transistor T3 may be referred to as a light emitting control transistor.

The fourth transistor T4 may include a gate electrode which receives an anode initialization gate signal EB, a first electrode connected to an initialization voltage line which supplies an initialization voltage VINT, and a second electrode connected to the third node N3. The fourth transistor T4 may be referred to as an anode initialization transistor. The first capacitor C1 may include a first electrode connected to the second node N2 and a second electrode connected to the first node N1.

The second capacitor C2 may include a first electrode connected to the first node N1 and a second electrode which receives the anode initialization gate signal EB.

The third capacitor C3 may include a first electrode connected to the first node N1 and a second electrode connected to the third node N3.

The light emitting element EL may include an anode connected to the third node N3 and a cathode connected to a second power supply voltage line which supplies a second power supply voltage ELVSS.

Referring to FIG. 10, the pixel PX″′ may include a first transistor T1, a second transistor T2, a third transistor T3, a fourth transistor T4, a first capacitor C1, a second capacitor C2, and a light emitting element EL.

The first transistor T1 may include a gate electrode connected to a first node N1, a first electrode connected to a second node N2, and a second electrode connected to a third node N3. The first transistor T1 may be referred to as a driving transistor.

The second transistor T2 may include a gate electrode which receives a data write gate signal GW, a first electrode connected to a data line DL which supplies a data voltage VDATA, and a second electrode connected to the first node N1. The second transistor T2 may be referred to as a data write transistor.

The third transistor T3 may include a gate electrode which receives an emission signal EM, a first electrode connected to a first power supply voltage line which supplies a first power supply voltage ELVDD, and a second electrode connected to the second node N2. The third transistor T3 may be referred to as a light emitting control transistor.

The fourth transistor T4 may include a gate electrode which receives an anode initialization gate signal EB, a first electrode connected to an initialization voltage line which supplies an initialization voltage VINT, and a second electrode connected to the third node N3. The fourth transistor T4 may be referred to as an anode initialization transistor.

The first capacitor C1 may include a first electrode connected to the second node N2 and a second electrode connected to the first node N1.

The second capacitor C2 may include a first electrode connected to the first power supply voltage line and a second electrode connected to the second node N2.

The light emitting element EL may include an anode connected to the third node N3 and a cathode connected to a second power supply voltage line that transmits a second power supply voltage ELVSS.

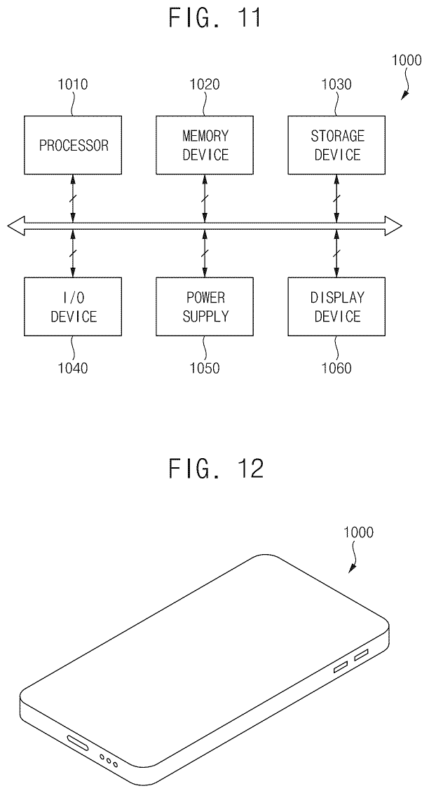

FIG. 11 is a block diagram illustrating an electronic device 1000. FIG. 12 is a diagram illustrating an embodiment in which an electronic device 1000 of FIG. 11 is implemented as a smartphone.

Referring to FIGS. 11 and 12, an electronic device 1000 may include a processor 1010, a memory device 1020, a storage device 1030, an input/output I/O device 1040, a power supply 1050, and a display device 1060. The display device 1060 may be the display device 10 of FIG. 1. In some aspects, the electronic device 1000 may further include a plurality of ports for communicating with a video card, a sound card, a memory card, a universal serial bus USB device, other electronic device, and the like.

In an embodiment, as illustrated in FIG. 12, the electronic device 1000 may be implemented as a smartphone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display HMD device, and the like.

The processor 1010 may perform various computing functions. The processor 1010 may be a microprocessor, a central processing unit CPU, an application processor AP, and the like. The processor 1010 may be coupled to other components via an address bus, a control bus, a data bus, and the like. Further, the processor 1010 may be coupled to an extended bus such as, for example, a peripheral component interconnection PCI bus.

The memory device 1020 may store data for operations of the electronic device 1000. For example, the memory device 1020 may include at least one nonvolatile memory device such as, for example, an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as, for example, a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as, for example, a keyboard, a keypad, a mouse device, a touch-pad, a touch-screen, and the like, and an output device such as, for example, a printer, a speaker, and the like. In some embodiments, the I/O device 1040 may include the display device 1060.

The power supply 1050 may provide power for operations of the electronic device 1000.

The display device 1060 may be connected to other components through buses or other communication links.

Aspects of the embodiments described herein may be applied to any display device and any electronic device including the touch panel. For example, aspects of the embodiments described herein may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, or the like.

The foregoing is illustrative of the inventive concept and is not to be construed as limiting thereof. Although example embodiments of the inventive concept have been described, those skilled in the art will readily appreciate that many modifications are possible in embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel comprising a first data line, a second data line, a first gate line, a second gate line, a first pixel connected to the first data line and the first gate line, and a second pixel connected to the second data line and the second gate line;
a data driver comprising an output channel which provides a first data voltage and a second data voltage to each of the first data line and the second data line;
a gate driver which respectively provides a first gate signal and a second gate signal to the first gate line and the second gate line; and
a demultiplexer which selectively connects the first data line to the output channel in response to a first switching signal and selectively connects the second data line to the output channel in response to a second switching signal.

2. The display device of claim 1, wherein the demultiplexer comprises:
a first switching element which selectively connects the first data line to the output channel in response to the first switching signal; and
a second switching element which selectively connects the second data line to the output channel in response to the second switching signal.

3. The display device of claim 1, wherein each of the first gate signal and the first switching signal has an on-level in a first duration and an off-level in a second duration.

4. The display device of claim 3, wherein each of the second gate signal and the second switching signal has the on-level in the first duration and the off-level in the second duration.

5. The display device of claim 4, wherein the first duration and the second duration are different with respect to time.

6. The display device of claim 5, wherein the first duration and the second duration each have a time length shorter than one frame.

7. The display device of claim 4, wherein a first switching element comprised in the demultiplexer:
turns on in response to the first switching signal having the on-level in the first duration, and
turns off in response to the first switching signal having the off-level in the second duration.

8. The display device of claim 7, wherein a second switching element comprised in the demultiplexer:
turns off in response to the second switching signal having the off-level in the first duration, and
turns on in response to the second switching signal having the on-level in the second duration.

9. The display device of claim 4, wherein the output channel outputs the first data voltage in the first duration and outputs the second data voltage in the second duration.

10. The display device of claim 9, wherein each of the first pixel and the second pixel comprises:
a driving transistor which generates a driving current; and
a data write transistor, and
wherein:
the data write transistor comprised in the first pixel transmits each of the first data voltage and the second data voltage to the driving transistor comprised in the first pixel, based on the first gate signal, and
the data write transistor comprised in the second pixel transmits each of the first data voltage and the second data voltage to the driving transistor comprised in the second pixel based, on the second gate signal.

11. The display device of claim 10, wherein the data write transistor of the first pixel:
turns on in response to the first gate signal having the on-level in the first duration, and
turns off in response to the first gate signal having the off-level in the second duration.

12. The display device of claim 11, wherein the data write transistor of the second pixel:
turns off in response to the second gate signal having the off-level in the first duration, and
turns on in response to the second gate signal having the on-level in the second duration.

13. The display device of claim 1, wherein the first pixel and the second pixel are comprised in a same pixel row.

14. The display device of claim 13, wherein the first pixel and the second pixel are arranged adjacent to each other.

15. The display device of claim 1, wherein each of the first pixel and the second pixel comprises:
a driving transistor comprising a gate electrode connected to a first node, a first electrode connected to a first power supply voltage line which supplies a first power supply voltage, and a second electrode;
a data write transistor comprising a gate electrode which receives a data write gate signal, a first electrode connected to a data line which transmits a data voltage, and a second electrode connected to the first node;
a storage capacitor comprising a first electrode connected to the first power supply voltage line and a second electrode connected to the first node; and
a light emitting element comprising an anode connected to the second electrode of the driving transistor and a cathode connected to a second power supply voltage line which supplies a second power supply voltage.

16. The display device of claim 1, wherein each of the first pixel and the second pixel comprises:
a driving transistor comprising a gate electrode connected to a first node, a first electrode connected to a first power supply voltage line which supplies a first power supply voltage, and a second electrode connected to a second node;
a data write transistor comprising a gate electrode which receives a data write gate signal, a first electrode connected to a data line which transmits a data voltage, and a second electrode connected to a third node;
a compensation transistor comprising a gate electrode which receives a compensation gate signal, a first electrode connected to the second node, and a second electrode connected to the first node;
a light emitting control transistor comprising a gate electrode which receives an emission signal, a first electrode connected to the second node, and a second electrode connected to a fourth node;
a storage capacitor comprising a first electrode connected to the third node and a second electrode connected to the first node; and
a light emitting element comprising an anode connected to the fourth node and a cathode connected to a second power supply voltage line which supplies a second power supply voltage.

17. The display device of claim 16, wherein each of the first pixel and the second pixel further comprises:
an anode initialization transistor comprising a gate electrode which receives an anode initialization gate signal, a first electrode connected to an initialization voltage line which supplies an initialization voltage, and a second electrode connected to the fourth node.

18. The display device of claim 17, wherein each of the first pixel and the second pixel further comprises:
a third node initialization transistor comprising a gate electrode which receives a third node initialization gate signal, a first electrode connected to a reference voltage line which supplies a reference voltage, and a second electrode connected to the third node; and
a first node initialization transistor comprising a gate electrode which receives a first node initialization gate signal, a first electrode connected to the reference voltage line, and a second electrode connected to the first node.

19. The display device of claim 1, wherein each of the first pixel and the second pixel comprises:
a driving transistor comprising a gate electrode connected to a first node, a first electrode connected to a second node, and a second electrode connected to a third node;
a data write transistor comprising a gate electrode which receives a data write gate signal, a first electrode connected to a data line which transmits a data voltage, and a second electrode connected to the first node;
a light emitting control transistor comprising a gate electrode which receives an emission signal, a first electrode connected to a first power supply voltage line which supplies a first power supply voltage, and a second electrode connected to the second node;
a first capacitor comprising a first electrode connected to the second node and a second electrode connected to the first node;
a third capacitor comprising a first electrode connected to the first node and a second electrode connected to the third node; and
a light emitting element comprising an anode connected to the third node and a cathode connected to a second power supply voltage line which supplies a second power supply voltage.

20. An electronic device comprising:
a display panel comprising a first data line, a second data line, a first gate line, a second gate line, a first pixel connected to the first data line and the first gate line, and a second pixel connected to the second data line and the second gate line;
a data driver comprising an output channel which provides a first data voltage and a second data voltage to each of the first data line and the second data line;
a gate driver which respectively provides a first gate signal and a second gate signal to the first gate line and the second gate line;
a demultiplexer which selectively connects the first data line to the output channel in response to a first switching signal and selectively connects the second data line to the output channel in response to a second switching signal;
a driving controller which controls the data driver and the gate driver; and
a processor which controls the driving controller.
